(19) United States
(12) Patent Application Publication
(10) Pub. No.: US 2014/0298074 A1
(43) Pub. Date: Oct. 2, 2014

(54) METHOD OF CALCULATING CPU UTILIZATION

(71) Applicant: GM GLOBAL TECHNOLOGY OPERATIONS LLC, Detroit, MI (US)

(72) Inventors: Terry Murrell, San Pedro, CA (US); Ray M. Ransom, Big Bear City, CA (US); Namal P. Kumara, Ypsilanti, MI (US)

(73) Assignee: GM GLOBAL TECHNOLOGY OPERATIONS LLC, Detroit, MI (US)

(21) Appl. No.: 13/853,106

(22) Filed: Mar. 29, 2013

(51) Int. Cl. G06F 1/04

(52) U.S. Cl. CPC G06F 1/04
USPC 713/502

(57) ABSTRACT

A method of determining processor utilization includes: counting, via a first counter on a processor, a number of elapsed clock cycles while code is being executed; counting, via a second counter on a processor, a total number of free-running clock cycles; and dividing the number of clock cycles where code is being executed by the total number of free-running clock cycles to determine a CPU utilization.

### TECHNICAL FIELD

The present invention relates generally to a hardware-based approach to calculating CPU utilization.

### BACKGROUND

A real time operating system is an operating environment for software that facilitates multiple time-critical tasks being performed by a processor according to predetermined execution frequencies and execution priorities. Such an operating system includes a complex methodology for scheduling various tasks such that the task is complete prior to the expiration of a deadline. During software development, it is important to understand the typical processor utilization to ensure that the code is sufficiently compact and ensure all deadlines are met.

### SUMMARY

A method of determining processor utilization includes: counting, via a first counter on a processor, a number of elapsed clock cycles while code is being executed; counting, via a second counter on a processor, a total number of free-running clock cycles; and dividing the number of clock cycles where code is being executed by the total number of free-running clock cycles to determine a CPU utilization.

In one configuration, the processor may include an instruction execution unit configured for software code execution, and a performance monitor unit configured to monitor the performance of the instruction execution unit. The performance monitor unit may be configured to operate separate from the instruction execution unit, and may maintain the first counter in a first register.

The step of counting the number of elapsed clock cycles where code is being executed may include: initializing the first counter to a predetermined value; detecting, via hardware, the start of an interrupt service routine; unfreezing the first counter to allow the counter to begin incrementing clock cycles; detecting, via hardware, the completion of the interrupt service routine; freezing the first counter to prevent the counter from further incrementing; and determining the number of clock cycles that have elapsed since the first counter was initialized.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic flow diagram of a method of determining processor utilization.

FIG. 2 is a schematic diagram of a processor core and associated memory.

FIG. 3 is a schematic flow diagram of a method of counting the number of elapsed clock cycles where code is being executed.

FIG. 4 is a schematic flow diagram of a method that may be performed by a low priority interrupt service routine to compute/report a CPU utilization rate.

FIG. 5 is a schematic flow diagram of a method that may be performed by a low priority interrupt service routine to compute/report the total CPU utilization rate.

### DETAILED DESCRIPTION

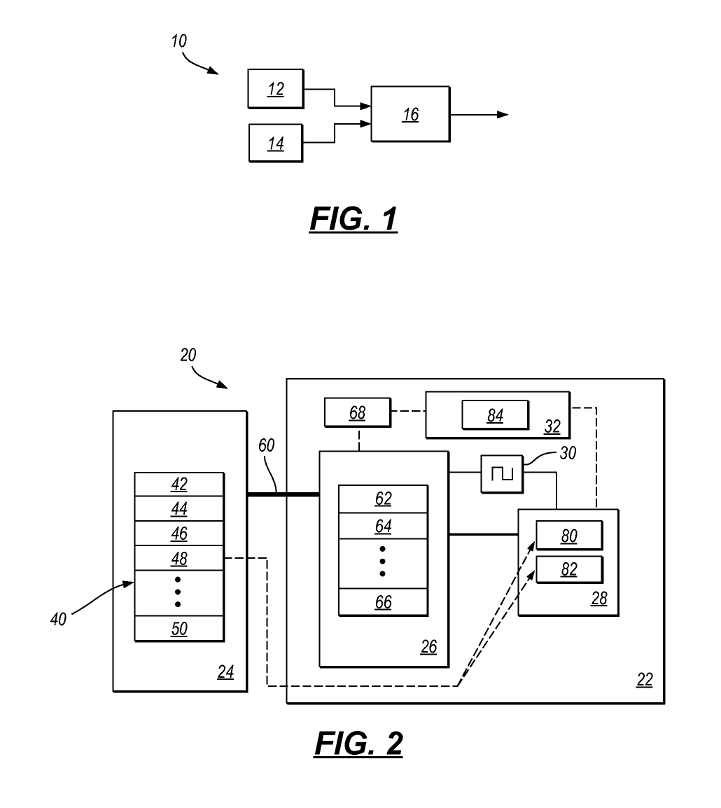

Referring to the drawings, wherein like reference numerals are used to identify like or identical components in the various views, FIG. 1 schematically illustrates a method 10 of determining processor utilization that includes counting, via a first counter on a processor, a number of elapsed clock cycles while code is being executed (step 12); counting, via a second counter on a processor, a total number of free-running clock cycles (step 14); and dividing the number of clock cycles where code is being executed by the total number of free-running clock cycles to determine a CPU utilization (step 16).

The present method 10 presents a substantially hardware-based approach to determining CPU utilization, which does not require software intervention to operate. This method may be used, for example, with any processor having a performance monitor unit that is separate from the core's general instruction execution unit.

In general, the performance monitor unit (or other hardware equivalents) is a customizable portion of the core that can count and/or time any of a number of predefined events. The performance monitor unit may be a fully autonomous logic circuit having customizable behavior according to the states of various dedicated memory registers. In other embodiments, the performance monitor unit may include certain low-level, dedicated processing capabilities to allow it to function in the manner described below. As presently configured, the performance monitor unit may be configured to allow the first counter to begin incrementing whenever an interrupt service routine (ISR) is being executed, and may suspend incrementing of the first counter when the ISR has completed and/or when the instruction execution unit has reverted back to a “background idle” task state.

FIG. 2 schematically illustrates a processor 20 that may embody the method 10 described above. The processor 20 may include a core/CPU 22, which may be in electronic communication with an associated memory module 24. The core 22 may include one or more instruction execution units 26, a performance monitor unit 28, a clock 30, and a machine state register (MSR) 32.

The memory module 24 may be, for example, non-volatile memory that is either on-board the processor 20, or readily accessible by the processor 20. The memory module 24 may include program memory 40 that includes a plurality of interrupt service routines (ISRs) (i.e., ISRs 42, 44, 46, 48, 50). Each ISR may be embodied by software code that is organized into a plurality of sequential commands to accomplish a particular task or computation. Each ISR may be assigned a respective frequency and/or priority at which it should be executed by the core 22.

Within the core 22, the instruction execution unit 26 may be responsible for general software code execution. The instruction execution unit 26 may be in communication with the memory module 24 via a communications bus 60, and may include a plurality of volatile general purpose registers 62, 64, 66. During the software execution, the instruction execution unit 26 may load and execute the various ISRs in a manner that respects their ideal execution frequency and/or priority. A programmable interrupt controller 68, for example, may schedule/prioritize the various ISRs for the instruction execution unit 26, and/or may manage one or more Interrupt Requests (IRQs). Based on the requested execution frequencies and timing, there may be periods of time in which the instruction execution unit 26 has completed the execution of an ISR, and not yet been instructed to begin a subsequent ISR. In these periods of time, the instruction execution unit 26 may operate in a “background idle” state, where it may execute other non-time-critical tasks and/or wait for the next interrupt to occur. While this description of code execution is likely an oversimplification of the operation of a typical microprocessor, it should be viewed as generally illustrative of the handling of ISRs in a real-time operating environment.

The performance monitor unit 28 may be in communication with a clock 30/oscillator that sets the cadence for all operations within the processor 20. In general, the clock 30 alternates between two states (i.e., high (1) and low (0)) on a regular and periodic basis. One cycle of the clock 30 may equal one full “high” state, and one full “low” state.

The performance monitor unit 28 may further include a first register 80 and a second register 82. Each of the first register 80 and second register 82 may be configured as counters to count cycles of the clock 30. The performance monitor unit 28 may be configured to “freeze” the first register 80 (i.e., temporarily suspend it from further counting) while the instruction execution unit 26 is in a background idle state, and may “unfreeze” (i.e., allow it to count/increment) while the instruction execution unit 26 is executing code from an ISR. Conversely, the second register 82 may be configured to continuously count clock cycles on a free-running basis, regardless of the behavior of the instruction execution unit 26.

The performance monitor unit 28 may selectively freeze and unfreeze the incrementing of the first register 80 specifically at the direction of a control bit 84 within the MSR 32 (i.e., the performance monitor mark (PMM) bit 84). More particularly, in one configuration, the PMM bit 84 may be set low when an interrupt occurs (i.e., when an ISR is called or initiated), and may return high when the ISR completes and/or when the instruction execution unit 26 returns to a background idle state. In one configuration, the PMM bit 84 may be toggled automatically between high and low states by the CPU 22 when an ISR is called/completed. For example, in one configuration, upon entry into an ISR, the CPU 22 may automatically (via hardware) set the PMM bit 84 low. Upon completion of the ISR, the CPU 22 may return the PMM bit 84 to whatever it was previously set to prior to that ISR. In addition to automatic hardware manipulation, the PMM bit 84 may be manually set to a particular value by software code that may be executed via the instruction execution unit 26. Said another way, in one configuration, PMM bit 84 in the MSR 32 may always be automatically cleared by the CPU 22 and then restored by the CPU 22 at the respective beginning and end of every interrupt. The code that is then executed within the interrupt may also selectively alter the state of the PMM bit 84 at a time between the hardware manipulations.

Periodically, and at a low priority an ISR (e.g., ISR 48) may interface with the first and/or second performance monitor unit registers 80, 82 to compute a CPU utilization rate (i.e., step 16 from FIG. 1), and subsequently reset the respective counters to a predetermined value (e.g., zero). In one embodiment, this utilization-computation ISR 48 may run approximately every 1000 ms to 2000 ms.

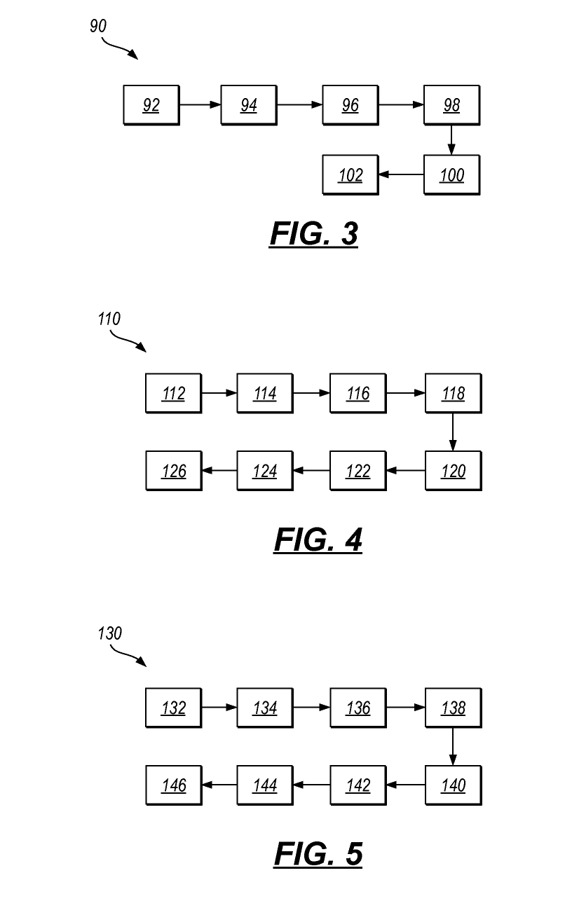

FIG. 3 generally illustrates one method 90 of counting the number of elapsed clock cycles where code is being executed, which may be implemented, for example, in step 12 of FIG. 1. Prior to the start of this method 90, the CPU 22 may initialize the performance monitor unit 28 to increment register 80 when the PMM bit 84 is in a low state. Additionally, either during the initialization of the CPU 22, or in an initial background state, the PMM bit 84 may be initialized high (i.e., where it will always then be high during the background idle state). As shown, the method 90 may then begin by initializing the first counter, stored in the first performance monitor unit register 80 to a predetermined value (step 92). This initialization step 92 may also occur within the background state of the CPU 22, and/or upon the startup of the processor. In step 94, the PMM bit 84 may be transitioned from high to low by the CPU 22 upon the start of an ISR. This transition to a low state will cause the performance monitor unit 28 to detect the start of the execution of an ISR. In step 96, the performance monitor unit 28 may respond to the change in the PMM bit 84 by unfreezing the first counter to allow the counter to begin incrementing clock cycles. In step 98, the PMM bit 84 may be returned to a high state (which existed prior to the start of the ISR) by the CPU 22 upon the completion of the ISR. The performance monitor unit 28 may respond to the change in the PMM bit 84 from low to high by freezing the first counter to prevent the counter from further incrementing in step 100. Following this, in step 102, the CPU 22 may determine the number of clock cycles that have elapsed since the first counter was initialized.

Using the number of clock cycles counted by the first counter, total CPU utilization may be computed in two slightly differing manners. FIG. 4 generally illustrates a method 110 that may be performed by a low priority ISR (e.g., ISR 48) to compute/report the total CPU utilization rate using both the first and second performance monitor unit registers 80, 82. Conversely, FIG. 5 illustrates a method 130 that may be performed by a low priority ISR (e.g., ISR 48) to compute/report the total CPU utilization rate using only the first performance monitor unit registers 80.

As shown in FIG. 4, the method 110 (performed by ISR 48) may begin at step 112 by disabling all interrupts. Once they are disabled, the ISR 48 may freeze both counters/registers 80, 82 (step 114), and subsequently read both counters (step 116). Prior to performing any calculations, the ISR 48 may then clear both counters (or reset them both to a predetermined value) at step 118, restart both counters at step 120, and enable interrupts at step 122. The ISR 48 may then compute a CPU utilization rate at step 124 by dividing the number of clock cycles accumulated by the first counter 80 (i.e., while code is being executed) by the number of free-running clock cycles accumulated by the second counter 82. The ISR 48 may then end at step 126.

While the method 110 illustrated in FIG. 4 provides the most accurate estimate of CPU utilization, the divide command performed in step 124 may not be available in certain processors or may require numerous clock cycles to perform. Therefore, as shown in FIG. 5, a modified method 130 may use only the first register 80, and may eliminate the intensive divide step. The method 130 shown in FIG. 5, however, does require a substantially fixed ISR execution period (i.e., for ISR 48), where “substantially fixed” is intended to mean that the processor 20 and/or programmable interrupt controller 68 makes every attempt to respect the fixed execution interval, though small deviations may be permitted as required by the real-time operating system.

As shown in FIG. 5, the method 130 (performed by ISR 48) may begin at step 132 by disabling all interrupts. Once interrupts are disabled, the ISR 48 may freeze the first (and only) counter/register 80 (step 134), and subsequently read that counter (step 136). The ISR 48 may then clear the counter 80 (or reset it to a predetermined value) at step 138, restart the counter at step 140, and enable interrupts at step 142. The ISR 48 may then compute a CPU utilization rate at step 144 by multiplying the number of clock cycles accumulated by the first counter 80 (i.e., while code is being executed) by a constant that is representative of the speed of the clock and the period between executions of the ISR 48 (indirectly deriving the total number of clock counts in the period). For example, if the clock speed is 200 MHz (i.e. 200 million cycles/second), and the period is 1000 ms, then the constant may be 1/200,000,000. The ISR 48 may then end at step 146.

While the methods 110, 130 described above are useful in determining a total processor utilization rate (i.e., processor utilization across all ISRs), the performance monitor unit 28 may also be used to aid in determining a utilization rate for one or more specific tasks (rather than for all tasks, as described above with respect to FIG. 3). In this manner, the performance monitor unit 28 may be configured to only unfreeze the counter/first register 80 if the ISR of interest is called/executed.

In a task-specific monitoring configuration the performance monitor unit 28 may be initialized to count clock cycles (i.e., increment register 80) only while the PMM bit 84 is set high (as opposed to when it is set low, which is described above with respect to FIG. 3). Additionally, during an initialization routine or initial background idle task, the PMM bit 84 may be set initially low. Therefore, absent more, the PMM bit 84 may initially be in a low state, may be forced low (i.e., may remain low) upon entry into an ISR, and then may return to the previous low state upon completion of the ISR. This is different from the total CPU utilization monitoring described above. Task monitoring may be effectuated by manually setting the PMM bit 84 high by software code upon entry to a specific task/ISR of interest. Upon setting the bit 84 high, the counter 80 may unfreeze to begin counting clock cycles. If a higher priority interrupt occurs, the PMM bit may be automatically set low again by h/w, to pause the counter 80. Upon completion of the higher priority interrupt, the counter 80 may be then automatically restored to its previous state (high) by hardware. In this way the counter is only running while the target task/ISR is executing. Upon completion of the target task/ISR the PMM bit 84 may be returned back to its original (low) state by the CPU 22, thus freezing the counter 80. Similarly, the PMM bit 84 bit will also remain low (counter-frozen) while in the background idle task. In this scenario, the setting and clearing of the PMM bit 84 by software is not required in any of the tasks other than the target ISR of interest. The count maintained by the register 80 may then be used in the manner described above with respect to FIGS. 4 and/or 5 to then determine a CPU utilization for the particular task/ISR of interest.

While the best modes for carrying out the invention have been described in detail, those familiar with the art to which this invention relates will recognize various alternative designs and embodiments for practicing the invention within the scope of the appended claims. The states of “high” and “low” for the PMM bit 84 should not be read as specifically limiting, though should be understood as being distinct from each other. It is contemplated that the performance monitor unit 28 may be configured to freeze a counter at a high state and unfreeze at a low state, or vice versa. It is intended that all matter contained in the above description or shown in the accompanying drawings shall be interpreted as illustrative only and not as limiting.

1. A method of determining processor utilization comprising:
counting, via a first counter on a processor, a number of elapsed clock cycles while code is being executed;
counting, via a second counter on the processor, a total number of free-running clock cycles;
dividing the number of clock cycles where code is being executed by the total number of free-running clock cycles to determine a CPU utilization;
wherein counting the number of elapsed clock cycles where code is being executed includes:
initializing the first counter to a predetermined value;
detecting, via hardware, the start of an interrupt service routine;
unfreezing the first counter to allow the counter to begin incrementing clock cycles;
detecting, via hardware, the completion of the interrupt service routine;
freezing the first counter to prevent the counter from further incrementing; and
determining the number of clock cycles that have elapsed since the first counter was initialized.

2. The method of claim 1, wherein the first counter is stored in a first register; and wherein the second counter is stored in a second register.

3. The method of claim 2, wherein the processor includes an instruction execution unit configured for software code execution, and a performance monitor unit;
wherein the performance monitor unit is configured to operate separate from the instruction execution unit; and
wherein the first counter is stored in a register maintained by the performance monitor unit.

4. The method of claim 1, wherein the processor includes an instruction execution unit configured for software code execution, and a performance monitor unit;
wherein the performance monitor unit is configured to operate separate from the instruction execution unit; and
wherein the first counter is stored in a register maintained by the performance monitor unit.

5. The method of claim 4, wherein detecting, via hardware, the start of an interrupt service routine is performed by the performance monitor unit.

6. The method of claim 1, wherein detecting, via hardware, the start of an interrupt service routine includes detecting the start of any interrupt service routine.

7. The method of claim 1, wherein detecting, via hardware, the start of an interrupt service routine includes detecting the start of a specific interrupt service routine.

8. The method of claim 1, further comprising resetting each of the first and second counters on a periodic basis.

9. The method of claim 1, further comprising freezing the first counter if the processor is in a background idle state.

10. A method of determining processor utilization comprising:
counting, via a first counter on a processor, a number of elapsed clock cycles while code is being executed;
determining a CPU utilization from the number of elapsed clock cycles while code is being executed;
wherein the processor includes an instruction execution unit configured for software code execution, and a performance monitor unit;
wherein the performance monitor unit is configured to operate separate from the instruction execution unit;
wherein the first counter is stored in a register maintained by the performance monitor unit; and
wherein counting the number of elapsed clock cycles where code is being executed includes:
initializing the first counter to a predetermined value;
detecting, via hardware, the start of an interrupt service routine;
unfreezing the first counter to allow the counter to begin incrementing clock cycles;
detecting, via hardware, the completion of the interrupt service routine;
freezing the first counter to prevent the counter from further incrementing; and
determining the number of clock cycles that have elapsed since the first counter was initialized.

11. The method of claim 10, wherein detecting, via hardware, the start of an interrupt service routine is performed by the performance monitor unit.

12. The method of claim 10, further comprising:
counting, via a second counter on a processor, a total number of free-running clock cycles; and
wherein determining a CPU utilization from the number of elapsed clock cycles while code is being executed includes dividing the number of clock cycles where code is being executed by the total number of free-running clock cycles to determine a CPU utilization.

13. The method of claim 10, wherein detecting, via hardware, the start of an interrupt service routine includes detecting the start of a specific interrupt service routine.

14. The method of claim 10, further comprising resetting each of the first and second counters on a periodic basis.

15. The method of claim 10, further comprising freezing the first counter if the instruction execution unit is in a background idle state.

16. A method of determining processor utilization comprising:
counting, via a counter on a processor, a number of elapsed clock cycles while code is being executed;
initiating a first interrupt service routine having a fixed execution period;
multiplying, within the interrupt service routine, the number of clock cycles where code is being executed by a constant to determine a processor utilization percentage; and
wherein the constant is equal to the inverse of the fixed execution period multiplied by a clock speed of the processor.

17. The method of claim 16, wherein the processor includes an instruction execution unit configured for software code execution, and a performance monitor unit;
wherein the performance monitor unit is configured to operate separate from the instruction execution unit; and
wherein the counter is stored in a register maintained by the performance monitor unit.

18. The method of claim 16, wherein counting the number of elapsed clock cycles where code is being executed includes:
initializing the counter to a predetermined value;
detecting, via hardware, the start of a second interrupt service routine;
unfreezing the counter to allow the counter to begin incrementing clock cycles;
detecting, via hardware, the completion of the interrupt service routine;
freezing the counter to prevent the counter from further incrementing; and
determining the number of clock cycles that have elapsed since the counter was initialized.
